(19) United States
(12) Patent Application Publication
(10) Pub. No.: US 2007/0074114 A1
(43) Pub. Date: Mar. 29, 2007

(54) Automated dialogue interface

(75) Inventors: Iqbal Adjali, Bedford (GB); Ogi Bataveljic, Bedford (GB); Marco De Boni, Bedford (GB); Malcolm Benjamin Dias, Bedford (GB); Robert Hurling, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/238,243

(22) Filed: Sep. 29, 2005

(51) Int. Cl. G06F 3/00

(52) U.S. Cl. 715/706

(57) ABSTRACT

A human-computer interface for automatic persuasive dialogue between the interface and a user and a method of operating such an interface. The method comprising presenting a user with an avatar or animated image for conveying information to the user and receiving real time data relating to a personal attribute of the user, so as to modify the visual appearance and/or audio output of the avatar or animated image as a function of the received data relating to a personal attribute of the user. In this way, a more engaging, context sensitive and generally more persuasive automatic dialogue can be generated between the interface and the user.

The present invention relates to automated dialogue systems and embodied conversational agents, and in particular relates to methods and apparatus for facilitating dialogues between automated systems and users.

Various forms of automated dialogue systems and interactive computing devices are known to exist in the prior art. For instance, auto-teller machines (ATMs) and informational kiosks have been commonly available for many years. However, the relatively recent emergence of mobile computing devices, such as laptops, personal digital assistants and smart mobile phones, has seen the development of new human-computer interfaces involving the use of embodied conversational agents in the form of avatars and animated graphics.

Such interfaces are able to provide a limited degree of human-computer interaction, in that the avatar can be programmed to exhibit emotional states and convey information or dialogue via appropriate animations etc. For instance, in mobile phone applications, recipients in a two-way telephone conversation can be respectively represented by an avatar (typically a human face) on the mobile phone of the other recipient. In this way, the users of the mobile phones become more emotionally engaged with the phone and the dialogue, as it instinctively feels more natural to interact with an animated representation of the other recipient.

However, a significant drawback of conventional interfaces and conversational agents is that they have no ‘intelligence’, in that they have no knowledge of the personal attributes of the user or users who interact with them, and therefore are unable to provide true emotional feedback and dynamic dialogue.

When humans converse with one another, a rapport is established by instinctively and intuitively observing the facial expressions, gestures and intonation of speech of the other person, while also having regard to the personal attributes of that person. Therefore, in order for an automated dialogue interface to emulate a natural human conversation having emotional feedback, the interface needs to have knowledge of the personal attributes and mannerisms of the user of the interface, so as to be able to modify a corresponding conversational agent in a suitably responsive manner.

An object of the present invention is to provide an automated dialogue interface that can sense and determine personal attributes of a user of the interface so as to produce a more engaging and context sensitive dialogue between the user and the interface.

Another object of the present invention is to provide an automated dialogue interface that can modify the visual appearance and/or audio output of an embodied conversational agent as a function of the personal attributes of a user of the interface.

Another object of the present invention is to provide an automated dialogue interface that can modify the visual appearance and/or audio output of an avatar or animated image by having knowledge of real time and historical data relating to the personal attributes of a user of the interface.

According to an aspect of the present invention there is provided a method of operating a human-computer interface, comprising:

presenting a user with an avatar or animated image for conveying information to the user;

receiving real time data relating to a personal attribute of the user; and

modifying the visual appearance and/or audio output of the avatar or animated image as a function of the received data relating to a personal attribute of the user.

According to another aspect of the present invention there is provided a human-computer interface for automated dialogue with a user, comprising:

means for presenting the user with an avatar or animated image for conveying information to the user;

means for receiving real time data relating to a personal attribute of the user; and

means for modifying the visual appearance and/or audio output of the avatar or animated image as a function of the received data relating to a personal attribute of the user.

Embodiments of the present invention will now be described in detail by way of example and with reference to the accompanying drawings in which:

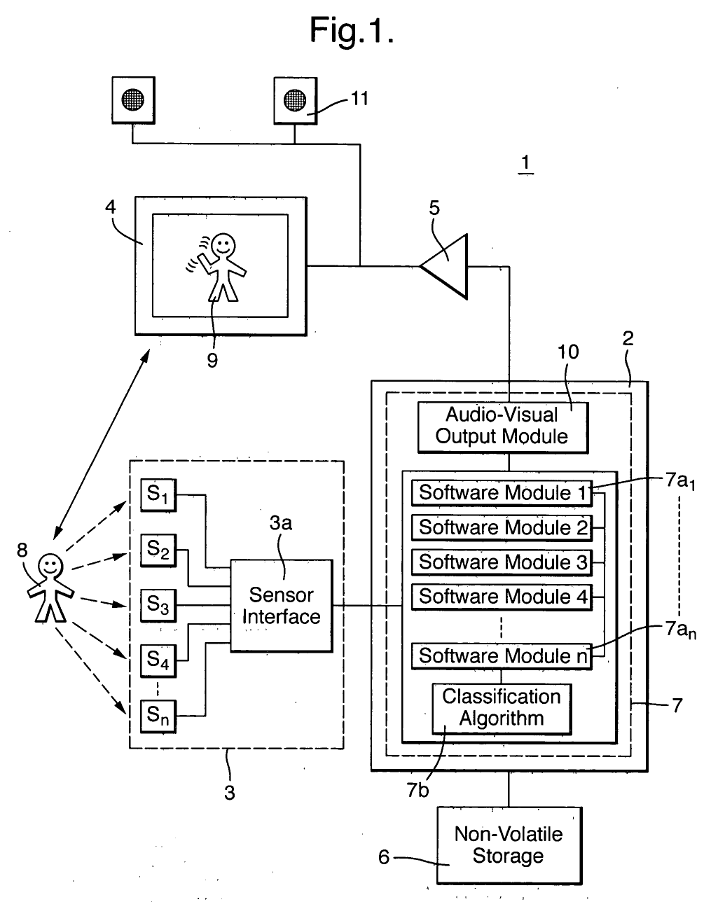

FIG. 1 is a schematic view of a particularly preferred arrangement of an automated dialogue interface according to the present invention.

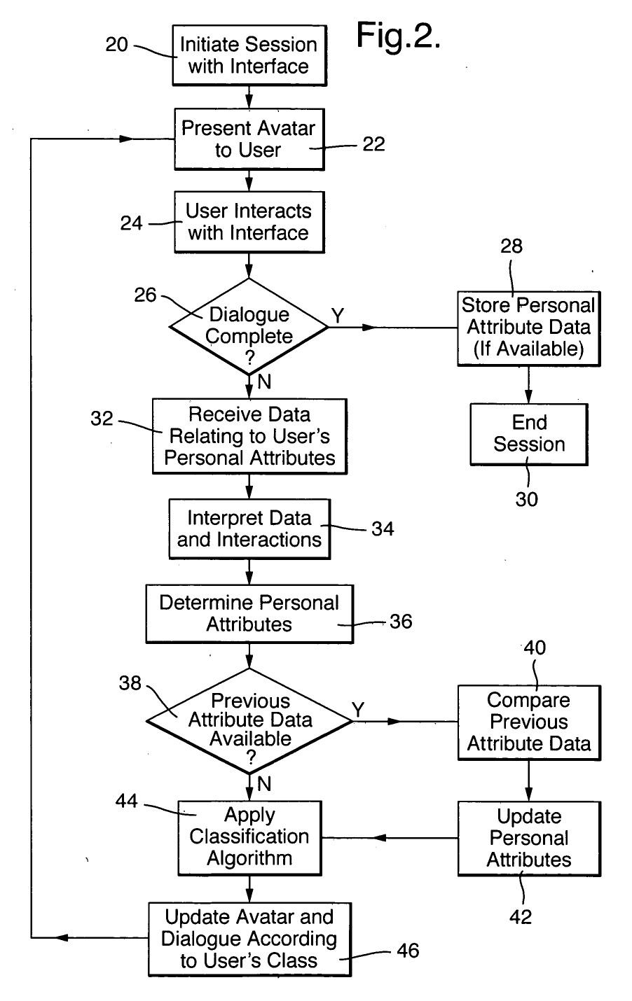

FIG. 2 is a flowchart of a preferred method of operating and using the interface of FIG. 1.

With reference to FIG. 1 there is shown a particularly preferred arrangement of an automated human-computer dialogue interface 1 (hereinafter referred to as the “interface”) according to the present invention. The interface 1 comprises a processor 2, a sensor array 3, a display device 4, an audio/video controller 5 and one or more storage devices 6 associated with the processor 2.

The interface 1 of the present invention may be implemented on any suitable computing device having a processor 2 capable of executing the automated dialogue application 7 of the present invention (discussed below). Preferred computing devices include, but are not limited to, desktop personal computers (PCs), laptop computers, personal digital assistants (PDAs), smart mobile phones, ATM machines, informational kiosks and electronic shopping assistants etc., modified, as appropriate, in accordance with the prescription of the following arrangements.

It is to be appreciated however, that the present interface 1 may be implemented on, or form a part thereof, of any suitable portable or permanently sited computing device, or appliance incorporating such a device, that is capable of interacting with a user (e.g. by receiving instructions and providing information by return).

In most applications, the processor 2 will correspond to one or more central processing units (CPUs) within the computing device, and it is to be understood that the present interface may be implemented using any suitable processor or processor type.

Preferably, the automated dialogue application 7 may be implemented using any suitable programming language, e.g. C, C++, JavaScript etc. and is preferably platform/operating system independent, to thereby provide portability of the application to different computing devices. In desktop PC and laptop applications for instance, it is intended that the automated dialogue application 7 be installed by accessing a suitable software repository, either remotely via the internet, or directly by inserting a suitable media containing the repository (e.g. CD-rom, DVD, Compact Flash, Secure Digital card etc.) into the computing device.

In accordance with the present invention, the automated dialogue application 7 is operable to determine the personal attributes of a user 8 of the interface 1 by receiving real time data relating to the attributes from one or more interactions between the interface 1 and the user 8. In this way, the automated dialogue application 7 is able to classify the user 8 according to his/her personal attributes so as to allow a more engaging and context sensitive automated dialogue to be established between the interface 1 and the user 8.

By ‘dialogue’ we mean an exchange of information or data between the interface 1 and user 8 either verbally, visually, textually or any combination thereof.

The automated dialogue application 7 is configured to control a conversational agent, preferably in the form of an avatar 9 or animated image, which engages in dialogue with the user 8 by way of the display device 4 and also typically an audio output device (e.g. conventional speakers or headphones etc.) 11. By having knowledge of the user's personal attributes, the automated dialogue application 7 can then modify the visual appearance and/or audio output of the conversational agent in a manner which is more suited and appropriate to the user 8.

The conversational agent is preferably implemented using any suitable programming language and associated graphical scripting language, and in preferred arrangements forms part of the automated dialogue application 7. However, in alternative arrangements, the conversational agent may be programmed in the form of a separate module which is dynamically linked to the application 7 during execution.

It is to be appreciated that any suitable digital image, graphic or sprite can be used as the avatar or animated image, and that the graphical/pictorial form of the conversational agent may represent both animate (e.g. human, animals etc.) and inanimate (e.g. teddy bear, computer, car etc.) objects as desired.

Preferably however, in most applications the avatar 9 or animated image is expected to be substantially anthropomorphic in appearance, so as to allow the human user 8 to converse more naturally and comfortably with the interface 1. Although the conversational agent is configured to be customisable, so that the user 8 can select a particularly preferred form of the agent.

The ‘personal attributes’ of a user typically relate to a plurality of both psychological and physiological characteristics that form a specific combination of features and qualities that define the ‘make-up’ of a person. Most personal attributes are not static characteristics, and hence they generally change or evolve over time as a person ages for instance. In the context of the present invention, the personal attributes of a user include, but are not limited to, gender, age, ethnic group, hair colour, eye colour, health, medical conditions, emotional state, personality type (e.g. dominant, submissive etc.), and may also include any psychological characteristics relating to their likes, dislikes, interests, hobbies, activities and lifestyle preferences.

However, it is to be appreciated that other attributes may be also be used to define the characteristics of, or relating to, a person and therefore any suitable attribute for the purpose of classifying a user 8 is intended to be within the meaning of ‘personal attribute’ in accordance with the present invention. According to a preferred arrangement, the personal attributes of the user 8 correspond to the user's physical attributes, and therefore the data received by the interface 1 relates to one or more physical attributes of the user.

The user 8 will typically approach the present interface 1 with a view to obtaining information of some kind (e.g. news, travel information, store locations etc.), or else may want to complete some particular task (e.g. dispense tickets, money, complete a tax return form etc.). Hence, the user 8 will ‘interact’ in some way or another with the interface 1.

In the context of the present invention, by ‘interaction’ we mean any form of mutual or reciprocal action that involves an exchange of information or data in some form, which may be with or without any physical contact between the interface 1 and the user 8. For example, interactions include, but are not limited to, touching the device on which the interface 1 is implemented (e.g. holding, pressing, gripping etc.), entering information into the device (e.g. by pressing a keypad), issuing verbal commands/instructions to the device (e.g. via continuous speech or discrete keywords), sensing the body temperature of the user, sensing chemical data related to the user (e.g. composition of perspiration) and capturing images of the user.

In preferred arrangements, the automated dialogue application 7 includes one or more software modules 7a₁ . . . 7aₙ, each module specifically adapted to process and interpret a different type of interaction between the interface 1 and the user 8. Alternatively, the automated dialogue application 7 may include only a single software module that is adapted to process and interpret a plurality of different types of interaction.

However, the ability to process and interpret a particular type of interaction depends on the kinds of interaction the device on which the interface 1 is implemented is able to support. Hence, for instance, if a ‘touching’ interaction is to be interpreted by a corresponding software module 7a₁ . . . 7aₙ, then the device will need to have some form of haptic interface (e.g. a touch sensitive keyboard, casing, mouse or screen etc.).

Therefore, in accordance with the present invention, the sensor array 3 (as shown in FIG. 1) preferably includes one or more of any of the following components, sensors or sensor types (shown as S₁ . . . Sₙ), either as an integral part of the device on which the interface 1 is implemented (e.g. built into the exterior housing/casing etc.) or as an ‘add-on’ or peripheral component (e.g. mouse, microphone, webcam etc.) attached to the device. The sensors S₁ . . . Sₙ communicate with the automated dialogue application 7 by way of a sensor interface 3a, which may be any suitable electronic circuit that is able to receive electrical signals from the one or more sensors S₁ . . . Sₙ and provide a corresponding output in a form suitable for interpretation by the automated dialogue application 7.

A Visual Sensor

This type of sensor will typically be in the form of a video camera, preferably based on conventional CCD (Charge Coupled Device) or CMOS (Complementary Metal Oxide Semiconductor) devices. The visual sensor S₁ may be built into the exterior housing or case of the device on which the interface 1 is implemented (e.g. as in mobile phone cameras), or else may be connected to the device by a hardwire or wireless connection etc. (e.g. such as a webcam).

The visual sensor S₁ is operable to obtain a 2-dimensional image of at least part of the user 8, preferably the user's face, either as a continuous stream of images or as discrete ‘snap-shot’ images, taken at periodic intervals, e.g. every 0.5 seconds. The images are provided to a corresponding software module, i.e. the ‘Visual Processing and Interpretation Module’ (VPIM) in the automated dialogue application 7, which preferably includes facial recognition, facial expression and gesture analysis processing algorithms.

The VPIM is configured to interpret images of the user's face in real time so as to determine the direction of the user's gaze (and hence their apparent attention) and analyse their facial expressions over the period of interaction with the interface 1. In this way, the attentive and/or emotional state of the user 8 may be directly assessed, thereby allowing the automated dialogue and conversational agent to be suitably adapted and updated as appropriate. Hence, from an analysis of the facial expressions of the user 8 it may be possible to determine whether the user is angry, relaxed, happy, sad, tearful, tense, bewildered, excited or nervous etc., all of which may be useful in determining personal attributes of the user 8.

In preferred arrangements, the VPIM interprets facial features and expressions by reference to a default calibration image of a model human face, which allows the user's features (e.g. nose, mouth, eyes etc.) to be mapped onto the corresponding features of the model. In this way, emotional states of the user 8 can be assessed in substantially real time by comparing the shape and relative displacement of the mapped features over a succession of consecutive images. Hence, for example, if the user 8 begins to smile during the dialogue with the interface 1, their mouth and brow will generally change shape and will gradually start to rise upwards, which will identified by the VPIM as corresponding to a typically happy emotional state.

By determining the approximate direction of the user's gaze, the VPIM can ascertain the degree of attentiveness exhibited by the user 8 during the dialogue with the interface 1. Hence, for example, should the user's gaze wander away from the display device 4, the VPIM will understand that the user 8 has either lost interest in the present dialogue, or else has been momentarily distracted by some other external influence. Should this be found to occur, the automated dialogue application 7 can then act to modify the conversational agent, either visually or audibly or both, so as to regain the user's attention and continue with a suitably updated dialogue.

In addition to determining the user's apparent attention and facial expressions, the VPIM is also preferably configured to interpret certain gestures or hand motions that are made by the user 8 when interacting with the interface 1. Most humans naturally use hand gestures and other body movements (e.g. head nodding, shoulder shrugging, waving hand etc.) when conversing, which if interpreted correctly by the interface 1 can be useful indicators of certain personal attributes, e.g. personality types etc.

Hence, the VPIM is preferably configured to use a gesture analysis algorithm which inspects the images of the user 8 to identify certain gestures or body movements that are exhibited by the user (depending on the size of the image and part of the user so imaged). Therefore, for example, any identified ‘head nodding’ will be taken to generally signify agreement with a particular point or fact of the dialogue, whereas ‘head shaking’ (from side to side) typically relates to a state of disagreement or dissatisfaction etc.

The gesture analysis algorithm preferably makes use of the model human face and mapped user features to determine head movement, but may also use other image processing techniques to establish direction and/or speed of motion of body parts and facial features etc.

In preferred arrangements, the VPIM is also able to make an assessment as to the gender of the user 8 based on the structure and features of the user's face. For instance, male users will typically have more distinct jaw-lines and more developed brow features than the majority of female users. Also, the presence of facial hair is usually a very good indicator of gender, and therefore, should the VPIM identify facial hair (e.g. a beard or moustache) this will be interpreted as being a characteristic of a male user.

Preferably, the VPIM may also determine the tone or colour of the user's face and therefore can determine the likely ethnic group to which the user 8 belongs. The tone or colour analysis is performed over selected areas of the face (i.e. a number of test locations are dynamically identified, preferably on the cheeks and forehead) and the ambient lighting conditions and environment are also taken into account, as a determination in poor lighting conditions could otherwise be unreliable.

The hair colour of the user 8 may also be determined using a colour analysis, operating in a similar manner to the skin tone analysis, e.g. by selecting areas of the hair framing the user's face. In this way, blonde, brunette and redhead hair types can be determined, as well as grey or white hair types, which may also be indicative of age. Moreover, should no hair be detected, this may also suggest that the user is balding, and consequently is likely to be a middle-aged, or older, male user. However, reference to other personal attributes may need to be made to avoid any confusion, as other users, either male or female, may have selected to adopt a shaven hair style.

The eye colour of the user 8 may also be determined by the VPIM by locating the user's eyes and then retinas in the images. An assessment of the surrounding part of the eye colour may also be made, as a reddening of the eye may be indicative of eye complaints (e.g. conjunctivitis, over-wearing of contact lenses or a chlorine-allergy arising from swimming etc.), long term lack of sleep (e.g. insomnia), or excessive alcoholic consumption. Furthermore, related to the latter activity, the surrounding part of the eye, may exhibit a ‘yellowing’ in colour which may be indicative of liver problems (e.g. liver sclerosis). Again, however, any colour assessment is preferably made with knowledge of the ambient lighting conditions and environment, so as to avoid unreliable assessments.

If in any of the colour determination analyses, i.e. skin tone, hair type and eye colour, the VPIM decides that the ambient conditions and/or environment may give rise to an unreliable determination of personal attributes, then it will not make any assessment until it believes that the conditions preventing a reliable determination are no longer present.

In assessing skin tone, the VPIM is also able to make a determination as to the user's complexion, so as to identify whether the user 8 suffers from any skin complaints (e.g. acne) or else may have some long term blemish (e.g. a mole or beauty mark), facial mark (e.g. a birth mark) or scarring (e.g. from an earlier wound or burning).

In certain cases, it also possible for the VPIM to determine whether the user 8 wears any form of optical aid, since a conventional edge detection algorithm is preferably configured to find features in the user's image corresponding to spectacle frames. In detecting a spectacle frame, the VPIM will attempt to assess whether any change in colouration is observed outside of the frame as compared to inside the frame, so as to decide whether the lens material is clear (e.g. as in normal spectacles) or coloured (i.e. as in sunglasses). In this way, it is hoped that the VPIM can better distinguish between user's who genuinely have poor eyesight and those who wear sunglasses for ultra-violet (UV) protection and/or for fashion.

It is to be appreciated however, that this determination may still not provide a conclusive answer as to whether the user has poor eyesight, as some forms of sunglasses contain lenses made to the user's prescription or else are of a form that react to ambient light levels (e.g. Polaroid lenses).

In some arrangements, the visual sensor S₁ may also function as a thermal imager (as discussed in above in relation to the temperature sensor), and therefore may also provide body temperature information about the user 8, which may be used in the manner described above to determine personal attributes of the user 8.

An Audio Sensor

This type of sensor will typically be in the form of a microphone that is built into the exterior housing or case of the device on which the interface 1 is implemented, or else may be connected to the device by a hardwire or wireless connection etc.

The audio sensor S₂ is operable to receive voice commands and/or verbal instructions from the user 8 which are issued by way of dialogue to the interface 1 in order to perform some function, e.g. requesting information. The audio sensor S₂ preferably responds to both continuous (i.e. ‘natural’) speech and/or discrete keyword instructions.

The audio information is provided to a corresponding software module, i.e. the ‘Audio Processing and Interpretation Module’ (APIM), which interprets the structure of the audio information and/or verbal content of the information to determine personal attributes of the user 8. The APIM preferably includes a number of conventional parsing algorithms, so as to parse natural language requests for subsequent analysis and interpretation.

The APIM is also configured to assess the intonation and prosody of the user's speech using standard voice processing and recognition algorithms to assess the personality type of the user 8. A reasonably loud, assertive, speech pattern will typically be taken to be indicative of a confident and dominant character type, whereas an imperceptibly low (e.g. whispery), speech pattern will usually be indicative of a shy, timid and submissive character type.

The intonation of a user's speech may also be used to assess whether the user 8 is experiencing stress or anxiety, as the human voice is generally a very good indicator of the emotional state of a user 8, and may also provide evidence of excitement, distress or nervousness. The human voice may also provide evidence of any health problems (e.g. a blocked nose or sinuses) or longer term physical conditions (e.g. a stammer or lisp etc.)

The APIM may also make an assessment of a user's gender, based on the structure and intonation of the speech, as generally a male voice will be deeper and lower pitched than a female voice, which is usually softer and higher pitched. Accents may also be determined by reference to how particular words, and therein vowels, are framed within the speech pattern. This can be useful in identifying what region of the country a user 8 may originate from or reside in. Moreover, this analysis may also provide information as to the ethnic group of the user 8.

The verbal content of the dialogue can also be used to determine personal attributes of the user 8, since a formal, grammatically correct sentence will generally be indicative of a more educated user, whereas a colloquial, or poorly constructed, sentence may suggest a user who is less educated, which in some cases could also be indicative of age (e.g. a teenager or child).

Preferably, the grammatical structure of the verbal content is analysed by a suitable grammatical parsing algorithm within the APIM.

Furthermore, the presence of one or more expletives in the verbal content, may also suggest a less educated user, or could possibly indicate that the user is stressed or anxious. Due to the proliferation of expletives in every day language, it is necessary for the APIM to also analyse the intonation of the sentence or instruction in which the expletive arises, as expletives may also be used to convey excitement on the part of the user or as an expression of disbelief etc.

Preferably, the APIM is configured to understand different languages (other than English) and therefore the above interpretation and assessment may be made for any of the languages for which the automated dialogue application 7 is intended for use. Therefore, the nationality of the user 8 may be determined by an assessment of the language used to interact with the interface 1.

It is to be appreciated that any suitable audio sensor may be used in connection with the interface 1, provided that it is able to produce a discernable signal that is capable of being processed and interpreted by the APIM.

A Pressure Sensor/Transducer

This type of sensor may form part of, or be associated with, the exterior housing or casing of the device on which the interface 1 is implemented. It may also, or instead, form part of, or be associated with, a data input area (e.g. screen, keyboard etc.) of the device, or form part of a peripheral device, e.g. built into the outer casing of a mouse etc.

For instance, the pressure sensor S₃ would be operable to sense how hard/soft the device is being held (e.g. tightness of grip) or how hard/soft the screen is being depressed (e.g. in the case of a PDA or ATM) or how hard/soft the keys of the keyboard are being pressed etc.

A corresponding software module, i.e. the ‘Pressure Processing and Interpretation Module’ (PPIM), in the automated dialogue application 7 receives the pressure information from the interactions between the device and user 8, by way of a sensor interface 3a coupled to the one or more pressure sensors S₃, and interprets the tightness of grip, the hardness/softness of the key/screen depressions and the pattern of holding the device etc. to establish personal attributes of the user 8.

The PPIM may also interpret pressure information concerning the points of contact of the user's fingers with the device (i.e. the pattern of holding), which could be useful in assessing whether the user is left handed or right handed etc.

Health diagnostics may also be performed by the PPIM to assess the general health or well-being of the user 8, by detecting the user's pulse (through their fingers and/or thumbs) when the device is being held or touched. In this way, the user's blood pressure may be monitored to assess whether the user 8 is stressed and/or has any possible medical problems or general illness.

It is to be appreciated that any suitable conventional pressure sensor or pressure transducer may be used in connection with the interface 1, provided that it is able to produce a discernable signal that is capable of being processed and interpreted by the PPIM. Moreover, any number of pressure sensors may be used to cover a particular portion and/or surface of the device on which the interface 1 is implemented, as required.

A Temperature Sensor

This type of sensor may form part of, or be associated with, the exterior housing or case of the device on which the interface 1 is implemented, in much the same manner as the pressure sensor S₃ above. It may also, or instead, form part of, or be associated with, a data input area (e.g. screen, keyboard etc.) of the device, or form part of a peripheral device, e.g. built into the outer casing of a mouse etc.

One or more temperature sensors S₄ gather temperature information from the points of contact between the device and the user 8 (e.g. from a user's hand when holding the device or from a user's hand resting on the device etc.), so as to provide the corresponding software module, i.e. the ‘Temperature Processing and Interpretation Module’ (TPIM), with information concerning the user's body temperature via the sensor interface 3a.

A user's palm is an ideal location from which to glean body temperature information, as this area is particularly responsive to stress and anxiety, or when the user is excited etc. Hence, a temperature sensor may be located in the outer casing of a mouse for instance, as generally the user's palm rests directly on the casing.

The temperature sensor S₄ may also be in the form of a thermal imaging camera, which captures an image of the user's face for instance, in order to gather body temperature information. The user's body temperature may then be assessed using conventional techniques by comparison to a standard thermal calibration model.

The TPIM interprets the temperature information to determine the personal attributes of the user 8, since an unusually high body temperature can denote stress or anxiety, or be indicative of periods of excitement. Moreover, the body temperature may also convey health or well-being information, such that a very high body temperature may possibly suggest that the user 8 is suffering from a fever or flu etc. at that time.

It is to be appreciated that any suitable conventional temperature sensor may be used in connection with the interface 1, provided that it is able to produce a discernable signal that is capable of being processed and interpreted by the TPIM. Moreover, any number of temperature sensors may be used to cover a particular portion or surface of the device on which the interface 1 is implemented, as required.

A Chemical Sensor

This type of sensor may form part of, or be associated with, the exterior housing or case of the device on which the interface 1 is implemented in much the same manner as the pressure S₃ and temperature S₄ sensors above. It may also, or instead, form part of, or be associated with, a data input area (e.g. screen, keyboard etc.) of the device, or form part of a peripheral device, e.g. built into the outer casing of a mouse etc.

The one or more chemical sensors Sₙ gather information from the points of contact between the device and the user 8, and are operable to sense the composition of the user's perspiration by preferably analysing the composition of body salts in the perspiration. By ‘body salts’ we mean any naturally occurring compounds found in human perspiration.

A user's fingertips and palm are ideal locations from which to glean perspiratory information, as these areas are particularly responsive to stress and anxiety, or when the user 8 is excited etc. Hence, a chemical sensor may be located in a keypad or on the outer casing of a mouse for instance.

The chemical information is interpreted by the ‘Chemical Processing and Interpretation Module’ (CPIM) in the automated dialogue application 7, which assesses whether the user 8 is exhibiting periods of stress or anxiety, or of excitement etc. The composition of the perspiration may also be indicative of the general health and well-being of the user 8, as the body salt composition of perspiration can change during illness.

The chemical sensor Sₙ may instead, or additionally, be in the form of an odour sensor and therefore does not need the user 8 to physically touch the device in order to assess whether the user 8 is perspiring etc.

It is to be appreciated that any suitable chemical sensor may be used in connection with the interface 1, provided that it is able to produce a discernable signal that is capable of being processed and interpreted by the CPIM. Moreover, any number of chemical sensors may be used to cover a particular portion or surface of the device on which the interface 1 is implemented, as required.

In preferred arrangements, at any point during the dialogue between the interface 1 and the user 8, the automated dialogue application 7 can decide that on the basis of the data provided by one or more of the software modules (e.g. VPIM, APIM, PPIM, TPIM and CPIM) at least one classification algorithm 7b is to be executed.

The classification algorithm 7b receives data from the respective software modules 7a₁ . . . 7aₙ that are, or were, involved in the most recent interaction(s) and uses that data to classify the user 8 according to his/her personal attributes. The data from the software modules 7a₁ . . . 7aₙ is based on the analysis and interpretations of those modules and corresponds to one or more of the personal attributes of the user 8. In preferred arrangements, the data is provided to the classification algorithm 7b by way of keyword meta-data which is preferably held in a memory associated with the interface 1 until required by the classification algorithm 7b.

In alternative arrangements, the keyword meta-data may be provided to the classification algorithm 7b by way of a conventional text-based file (e.g. including HTML and XML etc.) or any other suitable file type, generated by each respective software module 7a₁ . . . 7aₙ.

During execution, the classification algorithm 7b will compile the available keyword meta-data provided to it by the software modules 7a₁ . . . 7aₙ, and will proceed to resolve any conflicts between the determined personal attributes. Therefore, if the user's voice has indicated that the user 8 is happy, but the user's facial expression suggests otherwise, the classification algorithm 7b will then consult other determined personal attributes, so as to decide which attribute is most appropriate. Hence, in this example, the classification algorithm 7b may inspect any body temperature information, pressure information (e.g. tightness of grip/hardness of key presses etc.) and composition of the user's perspiration etc. in order to ascertain whether there is an underlying stress or other emotional problem that may have been masked by the user's voice.

In preferred arrangements, if any particular conflict between personal attributes cannot be resolved, the classification algorithm 7b will then apply a weighting algorithm which applies predetermined weights to keyword meta-data from particular software modules 7a₁ . . . 7aₙ. Hence, in this example, the facial expression information is weighted higher than voice information (i.e. greater weight is given to the personal attributes determined by the VPIM than those determined by the APIM), and therefore, the classification algorithm 7b would classify the user 8 based on an unhappy emotional state.

It is to be appreciated that any suitable weighting may be applied to the personal attributes from the software modules 7a₁ . . . 7aₙ, depending on the particular classification technique that is desired to be implemented by the classification algorithm 7b. However, in preferred arrangements the weights are assigned as follows (in highest to lowest order): VPIM→APIM→PPIM→TPIM→CPIM.

Hence, any dispute between personal attributes determined by the VPIM and the APIM, will be resolved (if in no other way) by applying a higher weight to the attributes of the VPIM than those of the APIM.

Following the resolution of any disputes, the classification algorithm 7b will then use the determined set of personal attributes of the user 8 to classify the user according to a predetermined class of user, so as to modify and update the dialogue conveyed by the conversational agent as appropriate. In this way, the dialogue can be made more engaging and context sensitive, so as to maintain the user's attention and provide a more persuasive content—which is particularly useful in sales applications e.g. e-commerce and electronic shopping assistants etc.

Therefore, the classification algorithm 7b will attempt to match the personal attributes of the user 8 to a plurality of hierarchically structured user classes which are associated with the algorithm 7b. In preferred arrangements, each ‘user class’ is separately defined by a predetermined set of one or more personal attribute criteria, which if found to correspond to the personal attributes of the user 8 will indicate the class of user to which the user belongs. For instance, the first two categories are male or female; then age group (e.g. <10 yrs, 10-15 yrs, 16-20 yrs, 21-30 yrs, 31-40 yrs, 41-50 yrs, 51-60 yrs, >60 yrs); ethnic group (e.g. Caucasian, black, asian etc.), hair colour (e.g. blond, brunette, redhead etc.) and so on, further sub-dividing through physical characteristics and then preferences—likes/dislikes, hobbies/interests/activities and lifestyle preferences etc.

When matching is complete, the classification algorithm 7b will then have identified the most appropriate user class for the user 8 of the interface 1, and hence the automated dialogue application 7 will have suitable knowledge of the user 8 so as to accordingly modify the visual appearance and/or audio output of the conversational agent.

A particular feature of the present invention, is that the interface 1 is configured to employ a technique of ‘continuance’, that is the interface 1 remembers (i.e. retains and stores) the personal attributes of the user 8 between dialogues with the interface 1. Therefore, the automated dialogue application 7 is adapted to search the storage devices 6 (e.g. non-volatile memory or hard disk drives etc.) of the interface 1 for any existing (or historical) personal attribute data related to the user 8—preferably prior to executing the one or more classification algorithms 7b.

Hence, should any existing personal attribute data be found to be available for a particular user 8, the automated dialogue application 7 will initially compare and update the existing data (where necessary and if appropriate) with that determined during the current dialogue, before causing the classification algorithm 7b to be executed.

In this way, the interface 1 can have an a priori knowledge of the user 8 before subsequent dialogue sessions, so that the conversational agent may already be in a form appropriately modified for that user 8 before the current dialogue begins. Thereafter, the conversational agent may be updated as necessary in accordance with the currently determined personal attributes of the user 8, should these have been found to have changed since the previous dialogue (e.g. change of emotional state, health etc.).

In preferred arrangements, the classification algorithm 7b provides an audio-visual output module 10 with an indication of the user class of the user 8 of the interface 1. This is preferably achieved by way of keyword meta-data in the same manner as providing data to the classification algorithm 7b (as described previously). Preferably, the audio-visual output module 10 is configured to modify the visual appearance and/or audio output of the conversational agent in accordance with the indicated class of the user 8.

Preferably, the output module 10 includes at least one image processing algorithm, which is adapted to change one or more visual characteristics of the avatar 9 or animated image, including, but not limited to, the colour, size, shape, outline, texture, transparency and permanency (i.e. whether constantly visible or blinking/flashing etc.).

Depending on the form of the avatar 9 or animated image, the output module 10 can impart any appropriate animated motion or movement to the contents of the rendered image, in addition to modifying one or more of any of the preceding characteristics. Hence, for example, if the avatar 9 is in the form of a human-like character (as shown in FIG. 1), the module 10 can cause the character to gesture or move (e.g. walk, wave its hand, shake its leg, perform a handstand etc.), or exhibit any facial expression (e.g. smile, wink, poke its tongue out etc.) as deemed appropriate for the class of the user 8 and ongoing dialogue.

Therefore, the avatar 9 or animated image can provide a form of emotional feedback to the user 8 of the interface 1, in that it can react in substantial real time to changes in the user's facial expressions, mannerisms and emotional state. Hence, should the user 8 smile or wave, a human-like avatar 9 can smile or wave back as appropriate.

Another example could be that, if the user 8 is deemed to be emotionally upset or distressed (from an analysis of their facial expression and/or speech pattern), a human-like avatar 9 could exhibit a generally sympathetic facial expression, which if it causes the user's spirits to noticeably lift, could then gradually morph into a smiling happy face.

The emotional feedback characteristics of the conversational agent may be enhanced further by the use of a suitable audio output. Hence, in preferred arrangements, the output module 10 also includes at least one voice synthesiser algorithm and at least one natural language parser, which are adapted to generate a substantially human-like voice audio output during the dialogue with the user 8. The content of the dialogue is dependent on the class of the user 8, and therefore the language parser is preferably adapted to alter the style of language, grammatical construction and colloquial content as appropriate to the user's class.

Preferably, the synthesiser algorithm is configured to alter one or more characteristics of the output voice in accordance with the class of the user 8. Hence, the volume, tone, speech prosody, accent and even gender of the output voice can each be modified as a result of having knowledge of the user's personal attributes.

Therefore, should the class of user indicate that the user 8 is a child below the age of 8 years old, the output voice can be modified to be female, softly-spoken, with an accent similar to the child's spoken dialect. Correspondingly, the avatar 9 or animated image can be modified to be female in appearance, having similar ethnic characteristics as the child etc. and either belonging to the child's age group or to an estimated age range corresponding to the child's mother.

In preferred arrangements, the output module 10 is configured so as to provide the audio/video controller 5 with video and/or audio control signals, to respectively drive the display device 4 and audio output device (e.g. speakers) 11.

The video control signals convey the conversational agent to the display device 4 for corresponding dialogue with the user 8. Preferably the display device 4 includes any suitable display technology, such as LCD, TFT and CRT.

The audio control signals provide a corresponding audio dialogue to the audio output device 11, which is synchronised with the corresponding animation of the avatar 9 or animated image.

Referring to FIG. 2, there is shown an exemplary flowchart of a preferred use of operation of the present interface 1. Hence, a user 8 when desiring to enter into a dialogue with the interface 1 will initiate a session with the interface (step 20) by either launching the automatic dialogue application 7 on their computing device, e.g. desktop PC, laptop etc., or by approaching a permanently sited device, like an ATM, informational kiosk or electronic shopping assistant etc.

The interface 1 will present the user 8 with a default avatar 9 or animated image (step 22), unless the user 8 is already known to the interface 1, in which case a previously modified avatar 9 will be displayed instead.

The user 8 will interact (step 24) with the interface 1 by issuing their request either by inputting text on a keypad or by providing a verbal command or instruction etc. From this time forward, any of the sensor or sensor types are operable to receive information concerning personal attributes of the user 8, unless the user 8 indicates that the dialogue has been completed (e.g. closes application, walks away from interface, requests return of ATM card etc.—step 26), in which case any personal attribute data (if available) is then stored (step 28) and the session is ended (step 30).

Otherwise, one or more of the sensors S₁ . . . Sₙ continue to receive data relating to the personal attributes of the user 8 (step 32). Any of the corresponding software modules 7a₁ . . . 7aₙ (VPIM, APIM, PPIM, TPIM and CPIM) will then commence processing and interpretation of the interactions (step 34) between the interface 1 and the user 8, in order to determine the personal attributes of the user (step 36).

The automated dialogue application 7 checks whether any existing personal attribute data is available (step 38) for that particular user, by searching the associated non-volatile storage device 6 (e.g. hard disk etc.). If existing data is found for that user 8, any historical personal attributes are compared to the currently determined attributes (step 40) and, if necessary, the historical data is then updated (step 42).

Whether any existing personal attribute data is found or not, the classification algorithm 7b is then applied (step 44) to the keyword meta-data provided by the one or more software modules 7a₁ . . . 7aₙ(VPIM, APIM, PPIM, TPIM and CPIM), which resolves any disputes between determined attributes and proceeds to classify the user 8 in accordance with a predetermined set of user classes.

Following classification of the user 8, the output module 10 is notified of the user's class, which then modifies and updates (step 46) the visual appearance and/or audio output of the avatar 9 or animated image so as to provide a more engaging and context sensitive dialogue to the user 8, having a high degree of emotional feedback, which naturally engages the user more readily and makes the user more receptive to persuasive content and suggestion.

The automated dialogue will continue between the user 8 and interface 1 until the user 8 requests the session to be ended (e.g. closes application), or the particular task is completed, or else the user performs some action that indicates no further dialogue is required or desired (e.g. walks away from the interface or requests return of ATM card etc.). Consequently, steps 28 and 30 will be then be performed, storing the personal attribute data for subsequent use and ending the session.

Although the human-computer interface of the present invention is ideal for mobile and desktop computing devices and permanently sited ticket dispensing or ATM machines, informational kiosks and shopping assistants etc., it will be recognised that one or more of the principles of the invention could be used in other applications, including automobile dashboards, supermarket trolleys and kitchen appliances, such as washing machines and dishwashers etc.

Other embodiments are taken to be within the scope of the accompanying claims.

1. A method of operating a human-computer interface, comprising:
presenting a user with an avatar or animated image for conveying information to the user;
receiving real time data relating to a personal attribute of the user; and
modifying the visual appearance and/or audio output of the avatar or animated image as a function of the received data relating to a personal attribute of the user.

2. The method of claim 1, wherein the step of receiving real time data relating to a personal attribute of the user is based on one or more interactions between the interface and the user.

3. The method of claim 1, wherein the real time data relating to a personal attribute of the user is derived from one or more of the following sensor types: video, audio, pressure, temperature and chemical.

4. The method of claim 1, in which the real time data relating to a personal attribute of the user is an image of at least part of the user.

5. The method of claim 1, further comprising interpreting the real time data relating to a personal attribute of the user so as to classify the user according to a predetermined class of user.

6. The method of claim 5, wherein interpreting involves processing an image of at least part of the user.

7. The method of claim 6, wherein the part of the user is the face and the processing includes recognising facial features and identifying facial expressions of the user.

8. The method of claim 5, wherein interpreting involves processing a speech pattern of at least part of a verbal instruction provided by the user.

9. The method of claim 5, wherein interpreting includes comparing historical data relating to personal attributes of the user.

10. The method of claim 1, further comprising storing the real time data relating to a personal attribute of the user on a non-volatile storage means.

11. The method of claim 1, wherein the visual appearance and/or audio output of the avatar or animated image are dependent on a predetermined class of user to which the user belongs.

12. The method of claim 1, in which modifying the visual appearance of the avatar or animated image involves changing one or more of the following characteristics: colour, size, shape, outline, texture, transparency and permanency.

13. The method of claim 1, in which modifying the audio output of the avatar or animated image involves changing one or more of the following characteristics: volume, language, punctuation, grammar, speech prosody, speech tone, accent and gender.

14. The method of claim 1, in which the avatar or animated image is substantially anthropomorphic in appearance.

15. The method of claim 1, further comprising rendering the avatar or animated image using an image processing algorithm in the interface.

16. The method of claim 1, wherein the personal attribute of the user is a physical attribute of that user.

17. A human-computer interface for automated dialogue with a user, comprising:
means for presenting the user with an avatar or animated image for conveying information to the user;
means for receiving real time data relating to a personal attribute of the user; and
means for modifying the visual appearance and/or audio output of the avatar or animated image as a function of the received data relating to a personal attribute of the user.

18. The interface of claim 17, wherein the means for receiving real time data relating to a personal attribute of the user include one or more of the following sensor types: video, audio, pressure, temperature and chemical.

19. The interface of claim 17, wherein the means for presenting the user with an avatar or animated image include an audio/video controller and a display device.

20. The interface of claim 17, further comprising an interpretation means including at least one classification algorithm for classifying the personal attributes of the user according to a predetermined class of user.

21. The interface of claim 17, wherein the means for modifying the visual appearance and/or audio output of the avatar or animated image include an image processing algorithm having a mode of operation dependent on a class of user to which the user belongs.

22. The interface of claim 17, wherein the personal attribute of the user is a physical attribute of that user.
